(19) United States
(12) Patent Application Publication
(10) Pub. No.: US 2015/0089426 A1
(43) Pub. Date: Mar. 26, 2015

(54) DEVICE FOR VEHICLE, COMPUTER-READABLE MEDIUM FOR DISPLAYING INFORMATION, AND SYSTEM FOR VEHICLE

(71) Applicant: DENSO CORPORATION, Kariya-city, Aichi-pref. (JP)

(72) Inventor: Hiroki Ukai, Nagoya-city (JP)

(21) Appl. No.: 14/397,769

(22) PCT Filed: Apr. 17, 2013
(86) PCT No.: PCT/JP2013/002600

§ 371 Date: Oct. 29, 2014

(30) Foreign Application Priority Data
May 7, 2012 (JP) 2012-106048
Jan. 28, 2013 (JP) 2013-013489

(51) Int. Cl. G06F 3/0484

(52) U.S. Cl. CPC G06F 3/04847; G06F 3/04842
USPC 715/771

(57) ABSTRACT

A device for a vehicle that utilizes a content of an outside server by functioning in cooperation with a portable communication terminal that executes an application for utilizing the content includes: a communication device that communicates with the portable communication terminal; a display device that displays multiple contents acquired via the portable communication terminal; an operation input device that inputs an operation for selecting one content from the contents and for controlling the display device to display detailed information included in the one content; and a control device that performs a control for reducing an information amount of the detailed information to be less than an information amount of detailed information displayed on the portable communication terminal when the display device displays the detailed information, and controls the display device to display the one content with a reduced information amount.

### CROSS REFERENCE TO RELATED APPLICATION

This application is based on Japanese Patent Application No. 2012-106048 filed on May 7, 2012, and No. 2013-13489 filed on Jan. 28, 2013, the disclosures of which are incorporated herein by reference.

### TECHNICAL FIELD

The present disclosure relates to a device for a vehicle and a system for a vehicle, which are capable of using information provided from an outside server and to a computer-readable medium for displaying information provided from an outside server.

### BACKGROUND ART

An information distribution service to make information provided from a server connected to a network available is provided. In an application using map data, which is one of such an information distribution service, a terminal device and a portable communication terminal operate in cooperation, and a data volume to be transmitted is calculated on the portable communication terminal side to determine a display method of images and convert data while information is displayed on the terminal device side according to the data (for example, Patent Literature No. 1).

The information distribution service in recent years provides not only information for vehicles but also various types of information. Hence, instead of limiting an application as in Patent Literature No. 1, the vehicle device and the portable communication terminal are allowed to run a common application, so that the information distribution service becomes available also on the vehicle device side in the same manner as with the portable communication terminal.

However, in a typical information distribution service, an interface, for example, for the portable communication terminal is provided. Hence, when a common application is run, a screen same as a screen on the portable communication terminal is also displayed on the vehicle display side. In this case, displayed characters are small or a driver has to scroll the screen. Hence, the information distribution service has a problem that a screen displayed on the vehicle device is hard to see for the driver.

### PRIOR ART LITERATURES

### Patent Literature

Patent Literature 1: JP-A-2010-26104

### SUMMARY OF INVENTION

It is an object of the present disclosure to provide a device for a vehicle, a system for a vehicle, and a computer-readable medium for displaying information provided from an outside server, each of which is capable of enhancing a convenience when an information distribution service is used in a vehicle.

According to a first aspect of the present disclosure, a device for a vehicle that utilizes a content provided from an outside server by functioning in cooperation with a portable communication terminal that solely executes an application for utilizing the content includes: a communication device that communicates with the portable communication terminal; a display device that displays a plurality of contents acquired by the communication device via the portable communication terminal; an operation input device that inputs an operation for selecting one content from the plurality of contents displayed on the display device and for controlling the display device to display detailed information included in the one content; and a control device that performs a content edit process for reducing an information amount of the detailed information included in the one content to be less than an information amount of detailed information displayed on the portable communication terminal when the display device displays the detailed information included in the one content, and controls the display device to display the one content with an information amount reduced by the content edit process.

The device for the vehicle as above can provide a screen easy to see for a user by reducing an information amount of the content to be displayed on the vehicle-side display device. Hence, a convenience when an information distribution service is used in a vehicle can be enhanced.

According to a second aspect of the present disclosure, a non-transitory tangible computer-readable medium includes instructions being executed by a computer, the instructions including a computer-implemented method for executing an application to utilize a content provided from an outside server in a common configuration with a portable communication terminal by functioning in cooperation with the portable communication terminal. The instructions includes: communicating with the portable communication terminal; displaying a plurality of contents acquired from the outside server via the portable communication terminal by communicating with the portable communication terminal; receiving an operation to select one content from the plurality of contents displayed while displaying the plurality of contents, and to display detailed information included in the one content; and performing a content edit process for reducing an information amount of the detailed information included in the one content to be less than an information amount of detailed information displayed on the portable communication terminal when the detailed information included in the one content is displayed, and displaying the one content with an information amount reduced by the content edit process.

The configuration as above can provide a screen easy to see for a user by reducing an information amount of the content to be displayed. Hence, a convenience when an information distribution service is used in a vehicle can be enhanced.

According to a third aspect of the present disclosure, a system for a vehicle includes: a portable communication terminal that executes an application for utilizing a content provided from an outside server; and a device for a vehicle that utilizes the content by functioning in cooperation with the portable communication terminal. The portable communication terminal includes: a terminal-side display device that displays a plurality of contents acquired from the outside server; a terminal-side operation input device that inputs an operation to select one content from the plurality of contents displayed on the terminal-side display device and to display detailed information included in the one content on the terminal-side display device; and a terminal-side control device that controls the terminal-side display device to display the detailed information acquired from the outside server without reducing an information amount when the detailed information of the one content is displayed on the terminal-side display device. The vehicle device includes: a vehicle-side display device that displays the one content acquired via the portable communication terminal; and a vehicle-side control device that controls the vehicle-side display device to display only a part of the detailed information acquired from the portable communication terminal when the detailed information of the one content is displayed on the vehicle-side display device.

The configuration as above can provide a screen easy to see for a user by reducing an information amount of the content to be displayed on the vehicle-side display device. Hence, a convenience when an information distribution service is used in a vehicle can be enhanced.

### BRIEF DESCRIPTION OF DRAWINGS

The above and other objects, features and advantages of the present disclosure will become more apparent from the following detailed description made with reference to the accompanying drawings. In the drawings:

FIG. 1 is a view schematically showing a configuration of a vehicle system according to one embodiment disclosed herein;

FIG. 2 is a view schematically showing a configuration of a vehicle device;

FIG. 3 is a view schematically showing a configuration of a portable communication terminal;

FIG. 4 is a chart schematically depicting a main flow of control in the vehicle device;

FIG. 5 is a view schematically showing a home screen on the vehicle device;

FIG. 6 is a chart depicting a flow of information display processing by the vehicle device;

FIG. 7 is a view showing an example of a contest list screen on the vehicle device;

FIG. 8 is a view showing an example of a display configuration on the vehicle device after content edit processing;

FIG. 9A and FIG. 9B are views showing an example of a summary display screen on the portable communication terminal;

FIG. 10 is a view showing an example of a display configuration on the vehicle device by travelling restriction processing;

FIG. 11 is a view showing an example of a photo news list display on the vehicle device;

FIG. 12 is a view showing an example of a display configuration on the vehicle device after the content edit processing;

FIG. 13A and FIG. 13B are views showing examples of a display configuration on the portable communication terminal;

FIG. 14A and FIG. 14B are views showing an example of a comparison of display configurations between the vehicle device and the portable communication terminal;

FIG. 15A and FIG. 15B are views showing an example of a comparison of display configurations between the vehicle device and the portable communication terminal;

FIG. 16 is a view showing an example of a map setting screen on the vehicle device;

FIG. 17A is a view showing an example of contents acquired from a server;

FIG. 17B is a view showing part of the contents of FIG. 17A;

FIG. 17C is a view showing part of the contents of FIG. 17A; and

FIG. 18 is a view showing an excerpt from acquired contents and used to display a summary.

### EMBODIMENTS FOR CARRYING OUT INVENTION

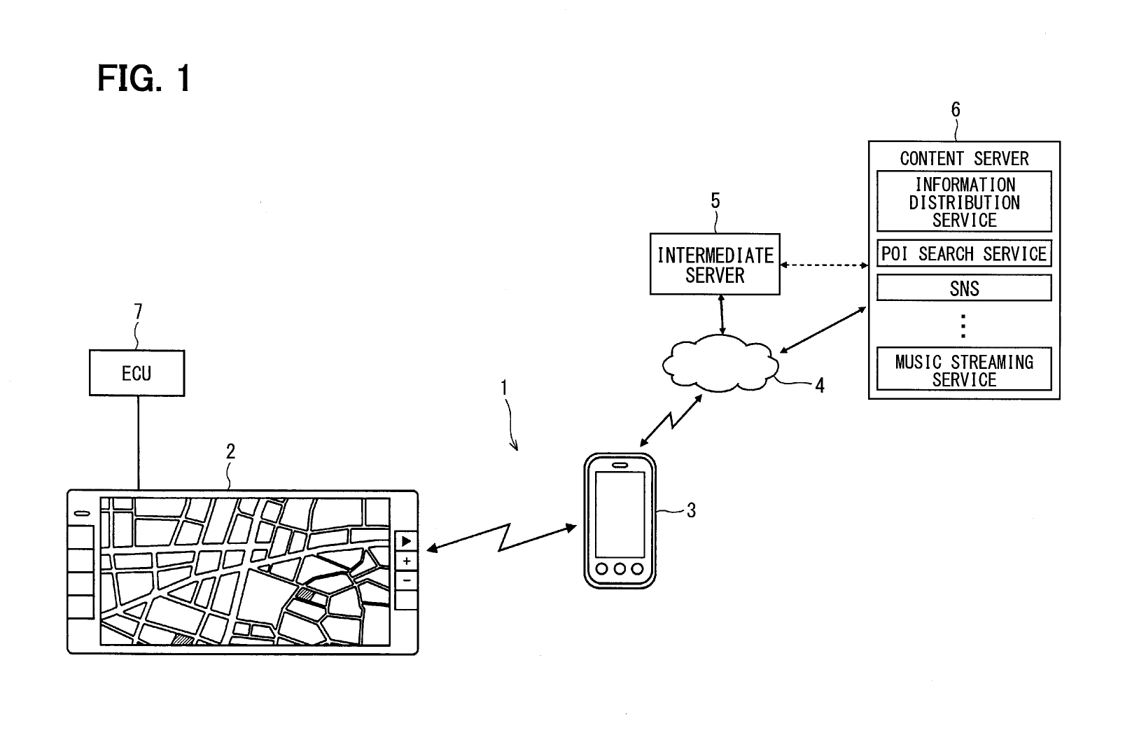

Hereinafter, an embodiment of the present disclosure will be described with reference to FIG. 1 through FIG. 16.

As is shown in FIG. 1, a vehicle system 1 includes a vehicle device 2 and a portable communication terminal 3. The vehicle system 1 is connected to an intermediate server 5 via an outside network 4 connected to the portable communication terminal 3 so that the vehicle system 1 and the intermediate server 5 can communicate with each other. The vehicle system 1 is also connected to a content server 6 to enable communications therebetween. The vehicle system 1 is equipped to an unillustrated vehicle. In this case, the vehicle device 2 is not limited to a type provided fixedly, for example, in an interior of the vehicle and can also be of a type provided in a movable manner.

Firstly, a utility form of contents in the vehicle system 1 will be described briefly. The vehicle system 1 can use various contents provided by the content server 6. Examples of available contents include but not limited to an information distribution service, a POI (Point Of Interest) search service, an SNS, and a music streaming service. These contents are provided by more than one content provider. In other words, for example, the SNS may be provided by a plurality of content providers, such as a provider AM, a provider BBB, and a provider CCC.

These contents are often provided in data formats determined by respective content providers. The vehicle system 1 is therefore connected to the intermediate server 5 that converts contents provided in various data formats from the respective content providers to a unified data format between the mobile terminal and the content server 6. Of various services mentioned above, a subject of this embodiment is the information distribution service.

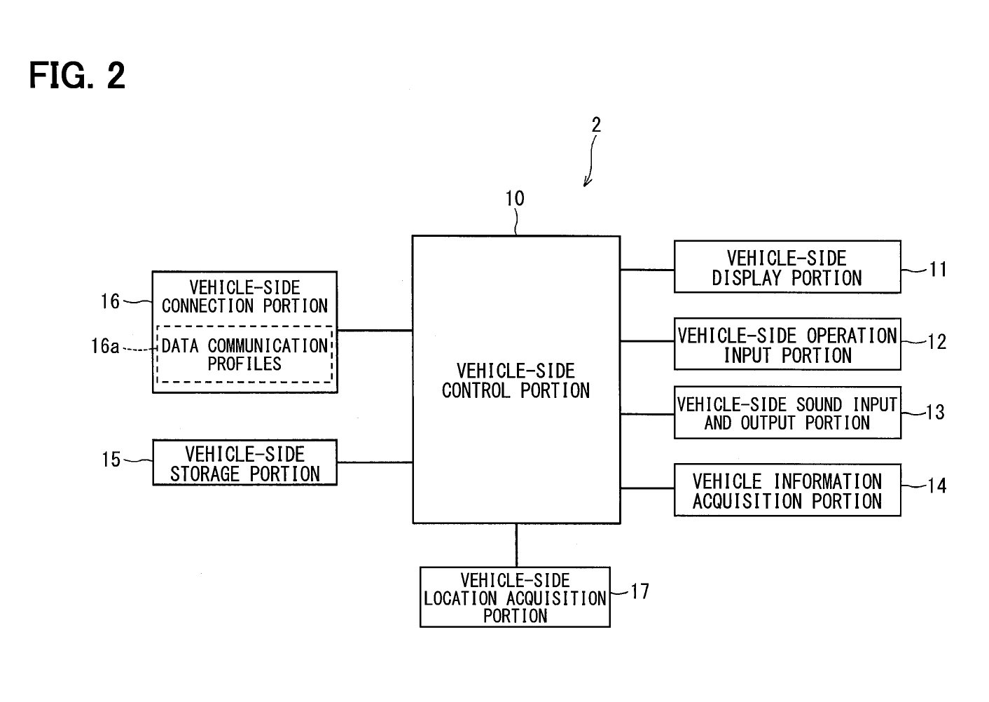

As is shown in FIG. 2, the vehicle device 2 has a vehicle-side control portion 10, a vehicle-side display portion 11, a vehicle-side operation input portion 12, a vehicle-side sound input and output portion 13, a vehicle information acquisition portion 14, a vehicle-side storage portion 15, a vehicle-side connection portion 16, and a vehicle-side location detection portion 17. The vehicle-side control portion 10 is formed of an unillustrated micro-computer having a CPU, a ROM, a RAM, and so on, and controls the entire vehicle device 2 according to programs stored in the ROM or the like. Also, the vehicle-side control portion 10 can run an application operating in cooperation with the portable communication terminal 3. Hence, the vehicle-side control portion 10 can operate in cooperation with the portable communication terminal 3 and also becomes able to use contents provided from an outside server in a configuration common with the portable communication terminal 3.

In this embodiment, processing itself to use the contents is performed by an application run on the portable communication terminal 3. More specifically, the portable communication terminal 3 does not function merely as a communication device, but uses contents according to an instruction from the vehicle device 2. The vehicle device 2 of this embodiment therefore functions as an operation terminal to operate the portable communication terminal 3. The vehicle-side control portion 10 forms a control device and a vehicle-side control device.

The vehicle-side display portion 11 is formed, for example, of a liquid crystal display, an organic EL display, or a plasma display, each of which is capable of displaying colors. The vehicle-side display portion 11 displays, for example, an operation screen and an application running screen of the image display device 2 or a map screen when a navigation function is in use. The vehicle-side display portion 11 forms a display device and a vehicle-side display device.

The vehicle-side operation input portion 12 is formed of a touch panel provided correspondingly to the vehicle-side display portion 11 and contact switches arranged on a periphery of the vehicle-side display portion 11. A user inputs an operation on the image display device 2 from these elements forming the vehicle-side operation input portion 12. A touch panel of any type, for example, a touch panel of a pressure-sensitive type, an electromagnetic induction type, or an electrostatic induction type, can be adopted. The vehicle-side operation input portion 12 forms an operation input device.

The vehicle-side sound input and output portion 13 has unillustrated speaker and microphone. The vehicle-side sound input and output portion 13 outputs, for example, music stored in the vehicle-side storage portion 15 and a guiding voice from the image display device 2. Also, a user's voice operation on the image display device 2 or the like is inputted into the vehicle-side sound input and output portion 13. The vehicle-side sound input and output portion 13 forms a sound output device.

The vehicle information acquisition portion 14 connects to an ECU 7 or the like and acquires various types of information on the vehicle. In this embodiment, the vehicle information acquisition portion 14 acquires vehicle information capable of determining whether the vehicle is travelling or not, more specifically, a speed of the vehicle, from the ECU 7. The vehicle information acquisition portion 14 forms a vehicle information acquisition device. The vehicle-side storage portion 15 stores therein music data, map data used for the navigation function, and various applications run on the vehicle device 2. The vehicle-side storage portion 15 also stores therein the vehicle information.

The vehicle-side connection portion 16 makes communications with the portable communication terminal 3. In this embodiment, a wireless communication system compatible with Bluetooth (registered trademark) is adopted. Hereinafter, Bluetooth (registered trademark) is abbreviated to BT and a connection by BT is referred to as the BT connection. The vehicle-side connection portion 16 has, for example, data communication profiles 16a (in the case of BT, corresponding to SPP and DUN), and connects to the portable communication terminal 3 using such profiles. The vehicle-side connection portion 16 forms a communication device.

The vehicle-side location detection portion 17 has so-called a GPS unit and a gyro sensor, and acquires an own location of the vehicle device 2, more specifically, an own location of the vehicle provided with the vehicle device 2. A method of acquiring an own location by the GPS unit or the like is known and a detailed description is omitted herein. The vehicle-side control portion 10 performs navigation processing to guide the vehicle to a destination according to an own location, that is, a location of the vehicle detected by the vehicle-side location detection portion 17.

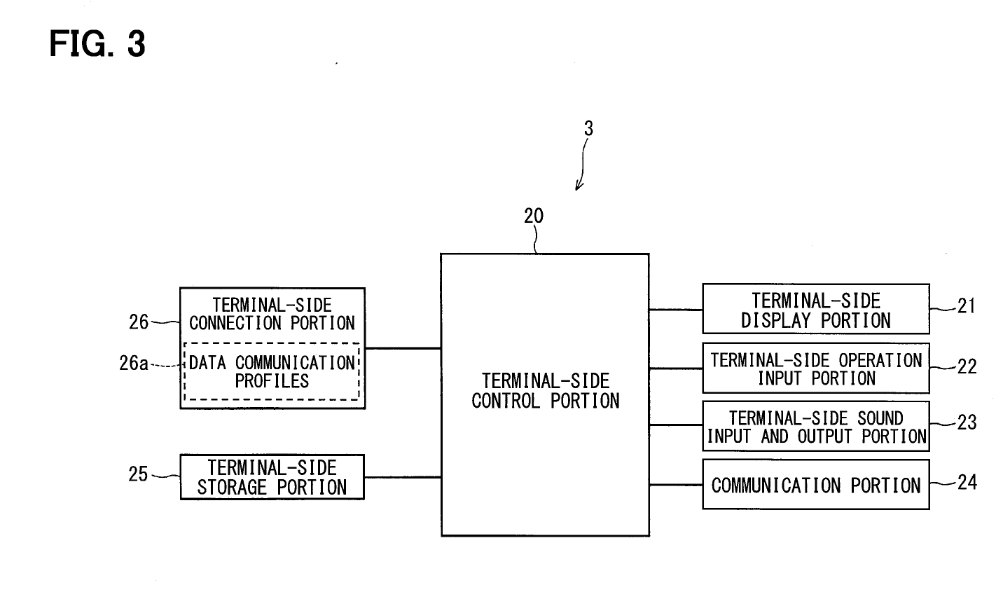

As is shown in FIG. 3, the portable communication terminal 3 has a terminal-side control portion 20, a terminal-side display portion 21, a terminal-side operation input portion 22, a terminal-side sound input and output portion 23, a communication portion 24, a terminal-side storage portion 25, and a terminal-side connection portion 26. In this embodiment, the portable communication terminal 3 is assumed to be so-called a smartphone. The terminal-side control portion 20 is formed of an unillustrated micro-computer having a CPU, a ROM, a RAM, and so on, and controls the entire portable communication terminal 3 according to programs stored in the ROM or the like. Also, the terminal-side control portion 20 can run an application operating in cooperation with the vehicle device 2. The terminal-side control portion 20 forms a terminal-side control device.

The terminal-side display portion 21 is formed, for example, of a liquid crystal display or an organic EL display, each of which is capable of displaying colors. The terminal-side display portion 21 displays, for example, phone book data, and images and videos stored, for example, in the terminal-side storage portion 25. The terminal-side display portion 21 forms a terminal-side display device. The terminal-side operation input portion 22 is formed of a touch panel provided correspondingly to the terminal-side display portion 21 and contact switches arranged on a periphery of the terminal-side display portion 21. An operation on the portable communication terminal 3 is inputted into the portable communication terminal 3 from these elements forming the terminal-side operation input portion 22. A touch panel of any type, for example, a touch panel of a pressure-sensitive type, an electromagnetic induction type, or an electrostatic induction type, can be adopted. The terminal-side operation input portion 22 forms a terminal-side operation input device.

The terminal-side sound input and output portion 23 has unillustrated microphone and speaker, and uttered sounds are inputted therein and received sounds are outputted therefrom during a call. The terminal-side sound input and output portion 23 also outputs, for example, music and sounds of videos stored in the terminal-side storage portion 25. The communication portion 24 performs a wide area communication by connecting to a public circuit-switched telephone network and the network 4. The communication portion 24 makes a call and transmits data to and receives data from the network 4. The terminal-side storage portion 25 stores therein phone book data and music as well as various applications run on the terminal-side devices and data saved by the user.

The terminal-side connection portion 26 makes communications with the vehicle device 2. In this embodiment, a BT-compatible wireless communication system is adopted as described above and the portable communication terminal 3 connects to the vehicle device 2 by a BT connection. As with the vehicle device 2, the terminal-side connection portion 26 has data communication profiles 27a (in this embodiment, SPP and DUN), and connects to the vehicle device 2 using such profiles. Profiles are not limited to data communication profiles and the terminal-side connection portion 26 may have, for example, a hands-free profile (HFP in the case of BT).

A function of the configuration as above will now be described. In a flowchart described in the following, the portable communication terminal 3 is denoted as SP (Smart Phone).

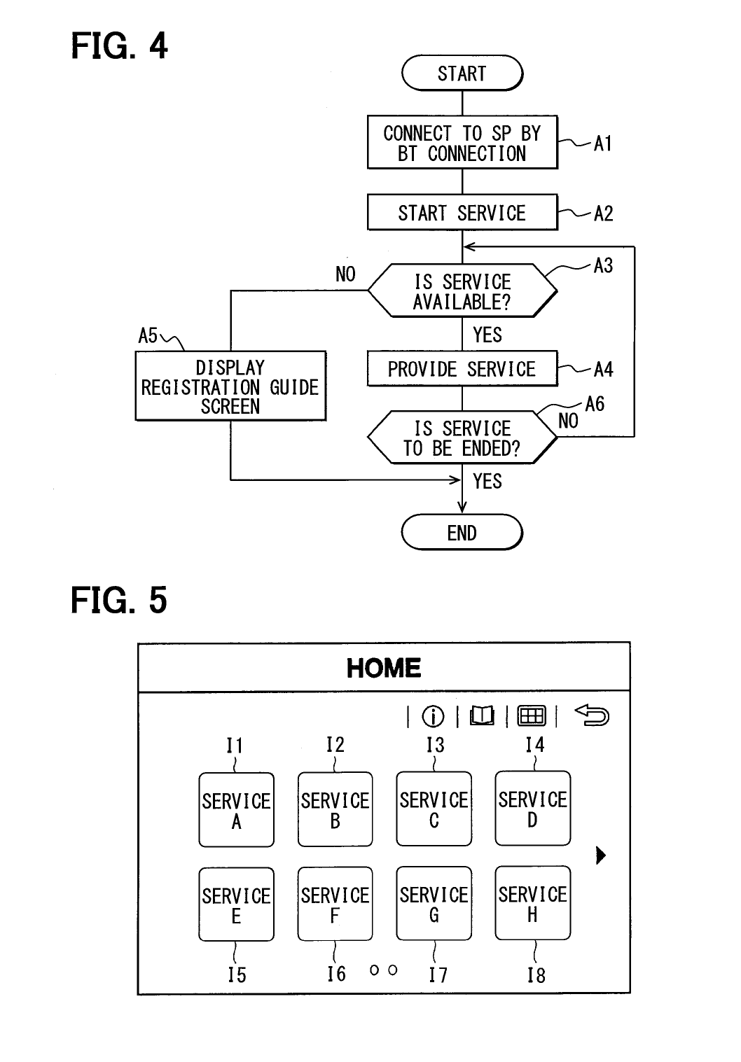

Firstly, a general flow of processing performed in the vehicle device 2 will be described with reference to FIG. 4 through FIG. 6. As is depicted in FIG. 4, after a start (ACC of the vehicle is switched ON), the vehicle device 2 connects to the portable communication terminal 3 (SP) by a BT connection (A1) and starts a service (A2). To start a service at Step A2 means to start running an application operating in cooperation with the portable communication terminal 3 so as to use a service (contents) provided from the content server 6 via the portable communication terminal 3. When the portable communication terminal 3 connects to the vehicle device 2, the portable communication terminal 3 restricts an input of an operation thereon by the user. More specifically, the portable communication terminal 3 restricts operations other than an operation to disconnect from the vehicle device 3. Meanwhile, an operation by the user is accepted at the vehicle device 2. In other words, the vehicle device 2 operates in cooperation with the portable communication terminal 3 by transmitting an operation by the user when the contents are used to the portable communication terminal 3 and also by displaying contents acquired at the portable communication terminal 3 on the vehicle device 2.

In this instance, as is shown in FIG. 5, the vehicle device 2 displays on the vehicle-side display portion 11 a home screen, in which icons I1 through I8 corresponding to contents to be used (that is, services to be used) are displayed. The user selects a desired service (see FIG. 1) by an operation to touch any one of the icons I1 through I8. In the case of FIG. 5, the icon I1 is provided correspondingly to a service A, the icon I2 to a service B, the icon I7 to a service C, and so on.

As is depicted in FIG. 4, the vehicle device 2 subsequently determines whether the selected service is available to the vehicle device 2 or not (A3). More specifically, the vehicle device 2 determines at Step A3 whether settings to use the service provided from the content service 6 are already made or not. For example, in order to use a service of the SNS, it is necessary to register account information of the SNS. Hence, when the service is not available, that is, when the initial settings are not finished yet (A3: NO), the vehicle device 2 displays, for example, an account registration guide screen (A5).

As is depicted in FIG. 4, when the initial settings are already made and the selected service is available (A3: YES), the vehicle device 2 provides the service (A4). The vehicle device 2 continues to provide the service until the user gives an instruction to end the service being provided (A6: NO). Meanwhile, the vehicle device 2 ends the processing when the user gives an end instruction (A6: YES).

In this manner, the vehicle device 2 can use the service selected by the user by operating in cooperation with the portable communication terminal 3.

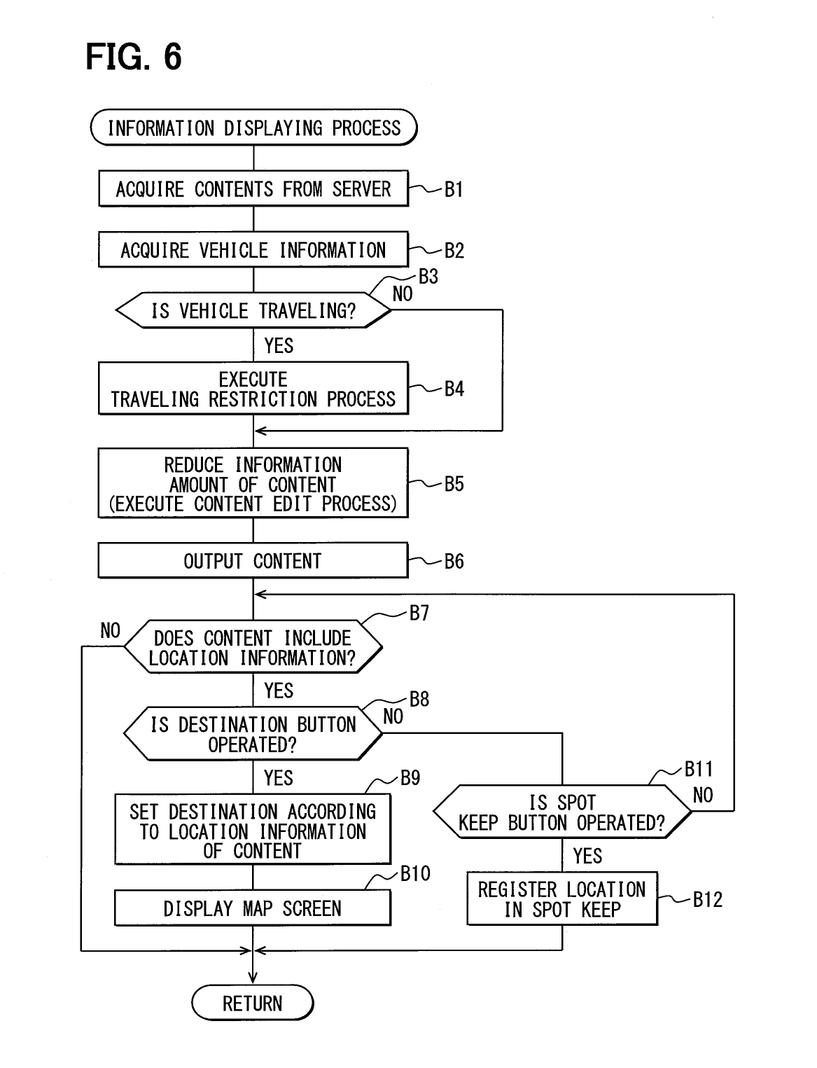

A description will now be given to an operation when using the information distribution service, which is the subject of the present disclosure, with reference to FIG. 6 through FIG. 16.

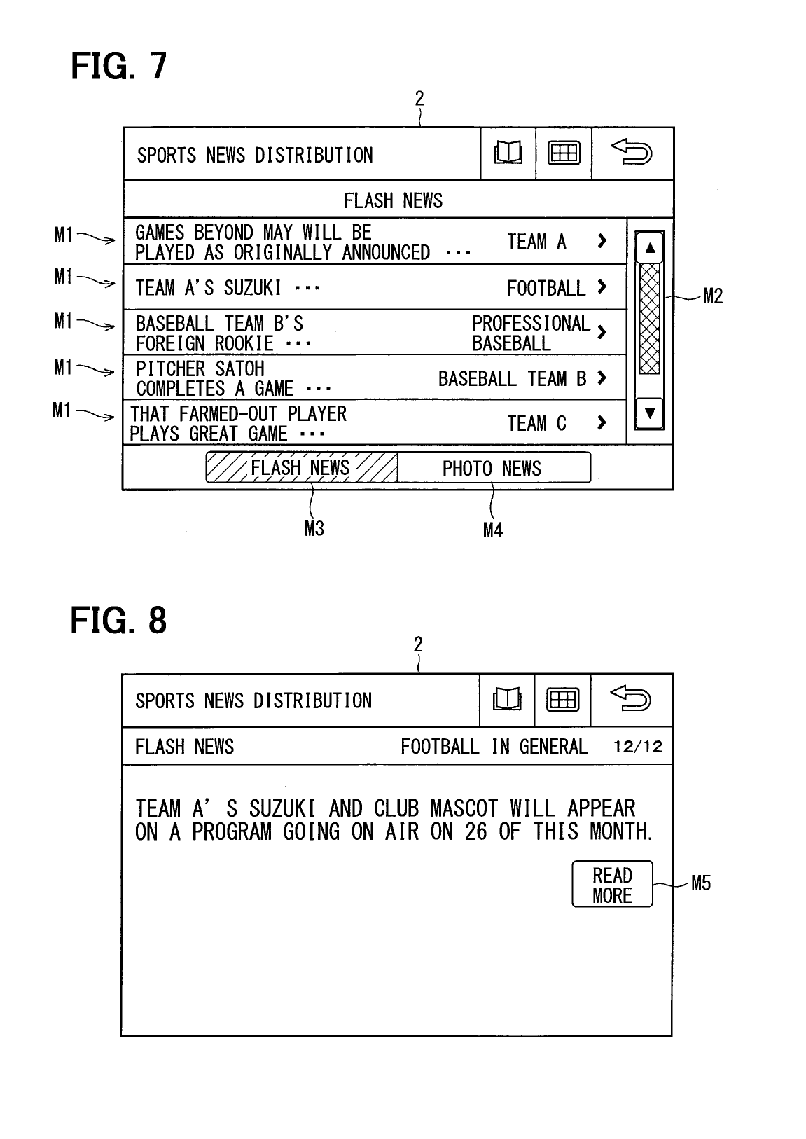

The vehicle device 2 performs information display processing depicted in FIG. 6. For example, when an icon I7 corresponding to sports news distribution (in this embodiment, corresponding to service G) is operated, the vehicle device 2 performs a communication procedure to acquire contents (information on sports or the like) from the server (content server 6). In this instance, the vehicle device 2 performs a display procedure (B1) to display a contest list screen displaying a list of the acquired contents as shown in FIG. 7. The contest list screen of FIG. 7 is provided with title display portions M1 to display a plurality of news titles (or leads of the news), a scroll bar M2 to scroll the list, a flash news tab M3 to select flash news displaying news in a text format, and photo news tab M4 to select photo news displaying news with a photo (image). In FIG. 7, flash news is displayed and the flash news tab M3 is hatched to schematically indicate that the flash news is selected now.

The user can browse detailed information of the content, that is, a body text of the news by an operation to touch the title display portion M1 provided correspondingly to the news he wishes to check on the contest list screen, that is, by inputting a selection operation.

When the contest list screen is displayed, the vehicle device 2 acquires the vehicle information capable of specifying whether the vehicle is traveling by means of the vehicle information acquisition portion 14 (B2) in the information display processing depicted in FIG. 6. The vehicle device 2 subsequently determines whether the vehicle is traveling or not on the basis of the vehicle information (B3). Upon determining that the vehicle is not travelling (B3: NO), the vehicle device 2 proceeds to Step B5. On the contrary, upon determining that the vehicle is traveling (B4: YES), the vehicle device 2 performs traveling restriction processing (B4). The traveling restriction processing will be described in detail below.

The vehicle device 2 subsequently performs content edit processing to reduce an information amount of the content (B3). The content edit processing is the processing to reduce an information amount of detailed information contained in the acquired content, more specifically, an information amount to be displayed on the vehicle-side display portion 11 to be less than an information amount of the detailed information displayed on the terminal-side display portion 21 of the portable communication terminal 3. In short, an information amount to be visually provided to the user is reduced in the vehicle device 2 of this embodiment. An information amount is reduced, for example, by methods (a) through (d) as follows.

(a) Display regions for respective types of detailed information contained in the acquired content and a character size displayed on each display region are set in advance and the display region is set as an upper limit of a display configuration. More specifically, for example, when a capacity of a given display region is set to two-line text data, text data exceeding two lines is not displayed therein.

(b) Of the detailed information contained in the acquired content, a type of detailed information to be displayed is set in advance, so that detailed information of the pre-set type is extracted and displayed. More specifically, when a title, a body text, an image (still image), a video (moving image), and the like are contained in the content, only the title and the image are displayed.

(c) When a plurality of pieces of information of the same type are contained in the detailed information contained in the acquired content, any one of these pieces of the detailed information is displayed. More specifically, for example, when a plurality of images are contacted in the content, only one of these images is displayed.

(d) Of the detailed information contained in the acquired content, a summary of information containing text data is extracted or created and the summary is displayed. More specifically, for example, when a summary is contained at the beginning of the body text or a summary portion is explicitly stated in the body text, the summary portion is extracted. Alternatively, a summary may be created by extracting keywords from the body text and connecting these keywords. When is it difficult to extract or create a summary, a list of keywords extracted from the body text may be used as an alternative to the summary.

When a selection operation is inputted by the user (when the vehicle device 2 performs an operation input procedure) after the content edit processing, the vehicle device 2 output the content (B6). For example, when the content edit processing is performed by the method (d) above, the vehicle device 2 displays a summary screen as shown in FIG. 8. This summary screen displays a summary of the body text of the acquired content.

A summary extraction method will now be described concretely.

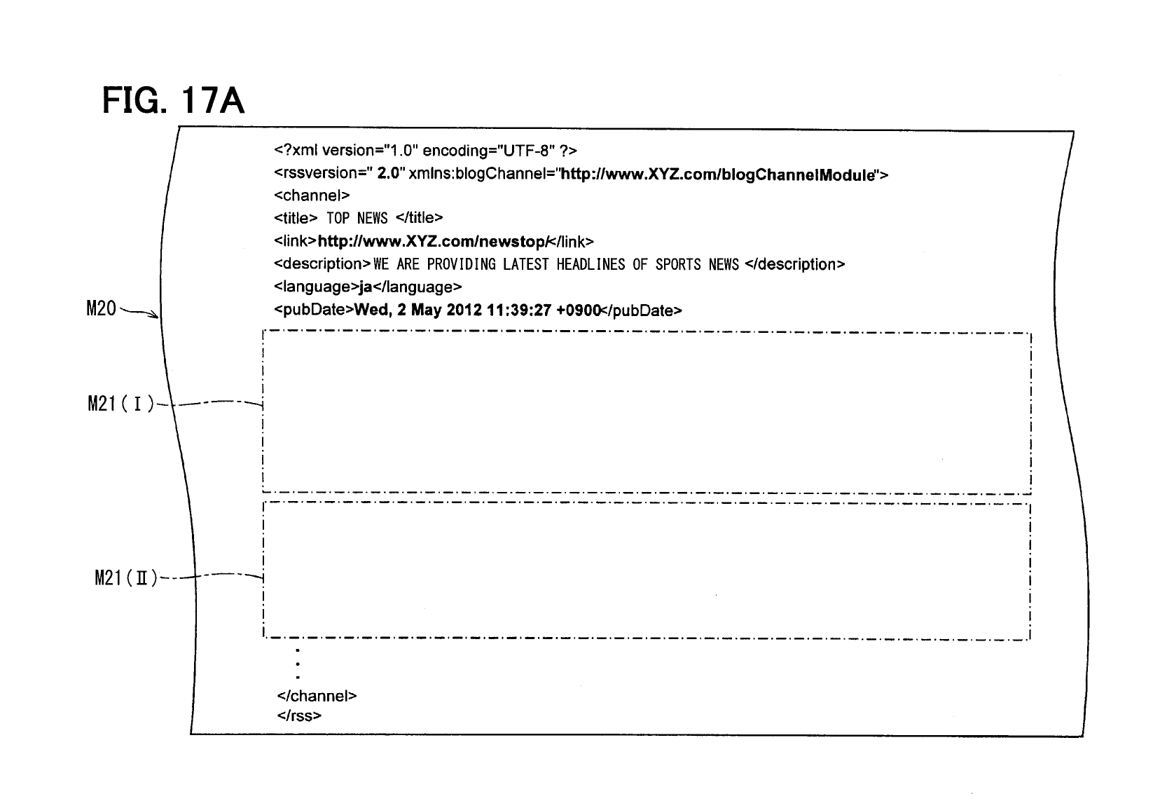

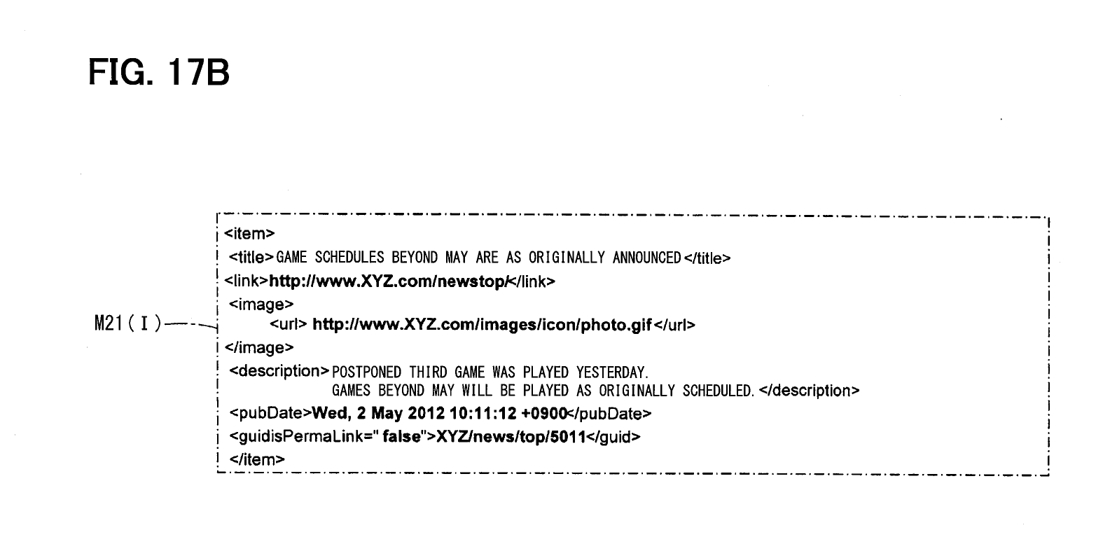

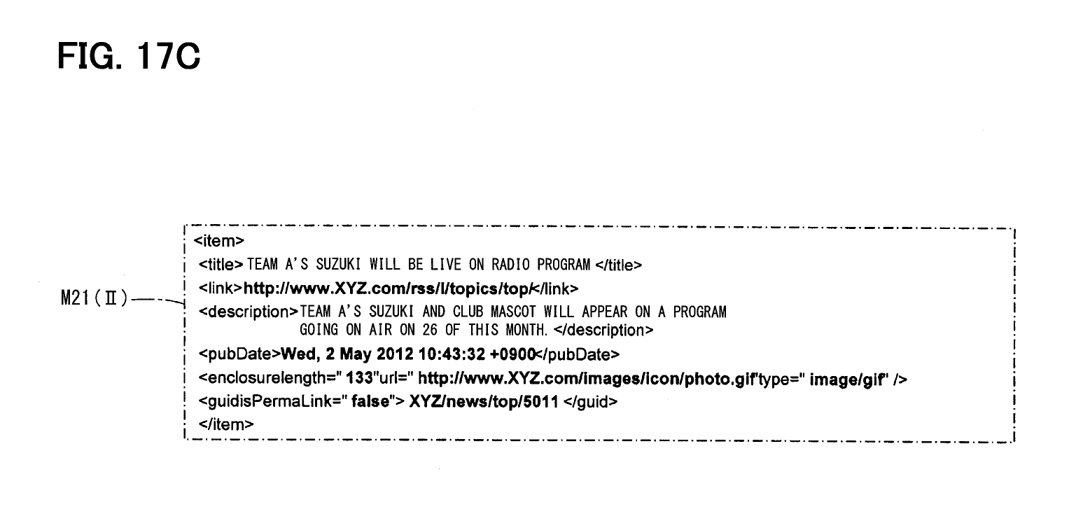

Contents acquired from the server can be text data written, for example, in an XML (Extensible Markup Language) as shown in FIG. 17A through FIG. 17C. Although the XML is known and a detailed description is omitted herein, the XML is a language to write in which manner data appear, such as a paragraph construction of sentences (descriptive content of contents) and a size and a color of fonts, as text data together with the sentences. Hereinafter, data written in the XML is referred to as an XML file M20 for ease of description. It should be appreciated that FIG. 17A through FIG. 17C show examples written in the XML and sentences and writing formats are not limited to those shown in FIG. 17A through 17C.

The XML file M20 contains a plurality of RSS fields M21(I) and M21 (II) placed between tags <item> and </item>. Herein, RSS means an XML-based format to write metadata, such as a headline and a summary of a WEB site, by restructuring and is chiefly used to release update information of the WEB site. What referred to as RSS at this time include a plurality of formats, such as RDF Site Summary (RSS 0.9 and RSS 1.0), Rich Site Summary (RSS 0.91), and Really Simple Syndication (RSS 2.0). Although a writing method and usage of each RSS is different, these are referred to collectively as the RSS herein. FIG. 17A through FIG. 17C show examples written in RSS 2.0.

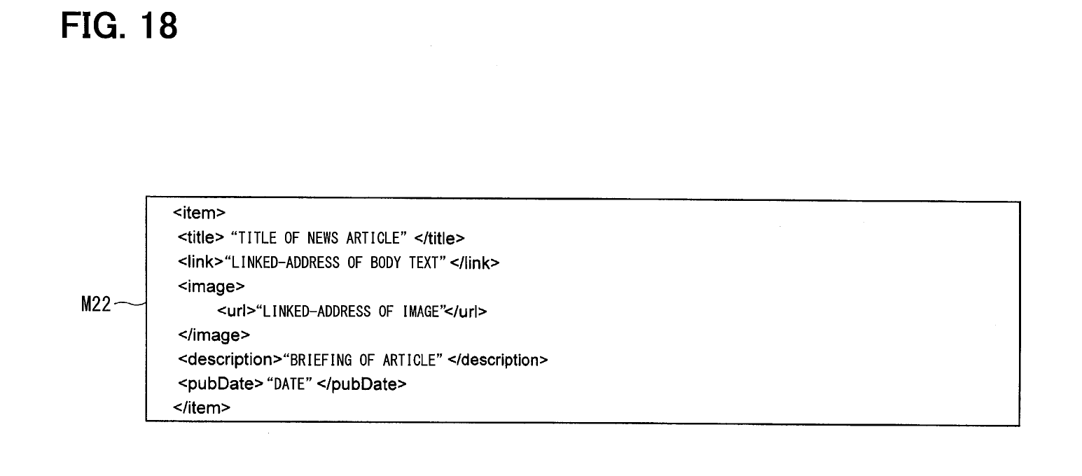

As is shown in FIG. 18, the RSS field 21 includes “title of news article”, “linked address of body text”, “linked address of image”, “briefing of article”, “date”, and so on. Of these items, “briefing of article” corresponds to the summary. That is, as will be described below, “briefing of article” in the RSS fields M21(I) and M21(II) is set in advance as the summary to be extracted in the vehicle device 2.

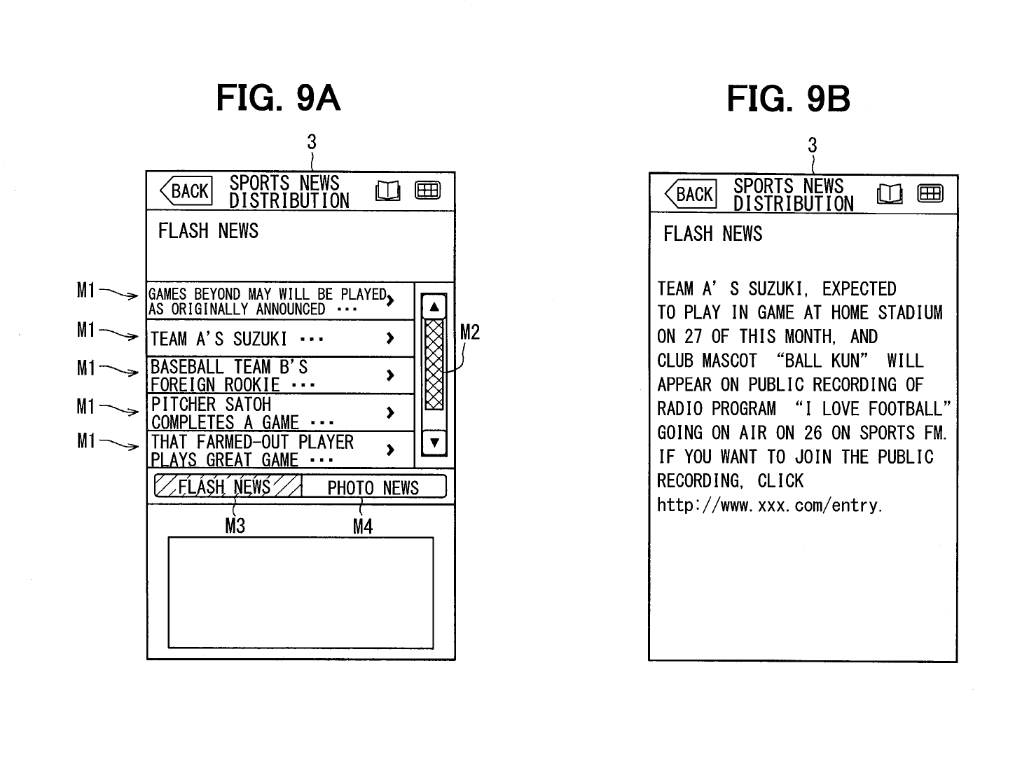

Firstly, a configuration in which the portable communication terminal 3 alone acquires and displays contents thereon will be described by comparison. When the portable communication terminal 3 acquires contents as shown in FIG. 17A through FIG. 17C, the portable communication terminal 3 displays titles written in the RSS fields M21(I) and M21(II) of the XML file M20 in the title display portions M1 as shown in FIG. 9A. When any one of the title display portions M1 is selected by the user, as is shown in FIG. 9B, the portable communication terminal 3 displays a full text of the content (that is, details of an article) at an URL set as a link in the RSS fields M21(I) and M21(II).

When the portable communication terminal 3 uses a sports news distribution service alone as above, the portable communication terminal 3 can display the details of the contents entirely. However, because an information amount being displayed is large, the user may possibly fix his eyes on the portable communication terminal 3. To eliminate such a risk, the vehicle device 2 reduces an information amount by displaying a summary of the content as will be described in the following.

When the vehicle device 2 acquires the contents as shown in FIG. 17A through FIG. 17C, the vehicle device 2 displays the contest list screen shown in FIG. 7 as described above. When any one of the title display portions M1 is selected by the user, the vehicle device 2 displays a summary of the article as shown in FIG. 8. The summary is portions placed between tags <description> and </description> in the RSS fields M21(I) and M21(II). In other words, the vehicle device 2 extracts summaries of the respective contents using descriptions in the RSS fields M21(I) and M21(II). More specifically, the vehicle device 2 reduces an information amount by setting in advance a type of information to be displayed to the title and the summary in the RSS field 21 and extracting information of the pre-set type from the content and displaying the extracted information.

As has been described, the vehicle device 2 outputs (displays) the content in a display configuration different from that of the portable communication terminal 3 by extracting a summary of the content. In other words, when the vehicle device 2 displays detailed information contained in a content for which a selection operation was inputted, the vehicle device 2 performs the content edit processing to reduce an information amount of the detailed information to be less than an information amount of the detailed information displayed on the portable communication terminal 3. The vehicle device 2 thus displays the content with an information amount reduced by the content edit processing.

Incidentally, when a summary is displayed, because an information amount is reduced as described above, the convenience is lowered more than necessary in some cases. To eliminate this drawback, the vehicle device 2 displays a read more button M5 on the summary screen. Although it is not shown in the drawing, when the user touches the read more button M5, the vehicle device 2 outputs the text data in a voice. Owing to this configuration, a screen easy to see for the user is provided on one hand and a possibility of lowering the convenience more than necessary is reduced on the other hand.

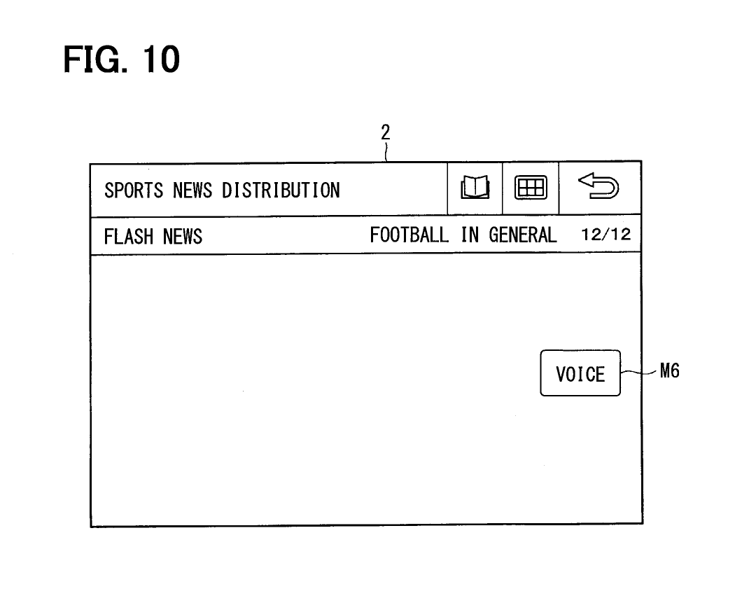

The traveling restriction mentioned above will now be described. The vehicle device 2 provides a screen easy to see for the user by performing the content edit processing to reduce an information amount. Nevertheless, the user may possibly take a look at the screen when the screen displays detailed information even when an information amount is reduced. To forestall such a risk, the vehicle device 2 is configured so as not to display detailed information at all as shown, for example, in FIG. 10 by performing the traveling restriction while the vehicle is travelling. A risk that the user fixes his eyes on the screen can be thus lowered. Herein, when the vehicle device 2 performs the traveling restriction processing, an input itself of a selection operation by the user, for example, on the contest list screen shown in FIG. 7 may be restricted.

In other words, the vehicle device 2 determines whether the vehicle is travelling or not on the basis of the vehicle information and restricts a display on the vehicle-side display portion 11 and/or an input to the vehicle-side operation input portion 12 upon determining that the vehicle is travelling. However, in order to prevent the convenience from being lowered more than necessary, for example, a voice button M6 may be provided so that an output in a voice is permitted even when the vehicle device 2 is performing the travelling restriction processing.

As has been described, the vehicle device 2 displays the acquired content in a state in which an information amount is reduced.

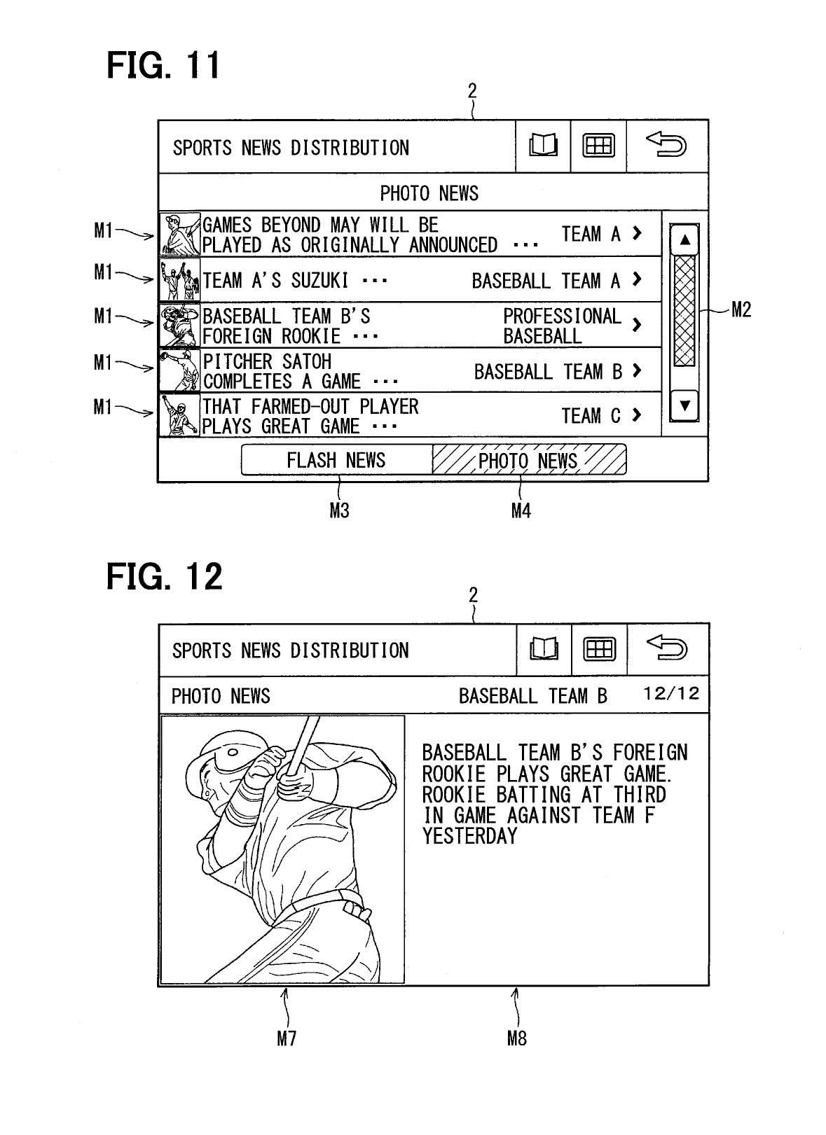

It should be noted that the vehicle device 2 is capable of displaying not only text data but also image data. For example, when the photo news tab M4 is operated on the contest list screen of FIG. 7, the vehicle device 2 displays a list of news with images as shown in FIG. 11. When any one item of news is selected by the user, the vehicle device 2 displays detailed information as shown in FIG. 12. In the case of FIG. 12, an image display portion M7, which is a region in which to display an image, is provided on a left side of the screen and a title display portion M8, which is a region in which to display a title, is provided on a right side of the screen. In other words, the vehicle device 2 sets a display region to display detailed information depending on a type of the detailed information (the method (b) above). In this case, the vehicle device 2 reduces an amount of information by displaying only the title instead of the body text.

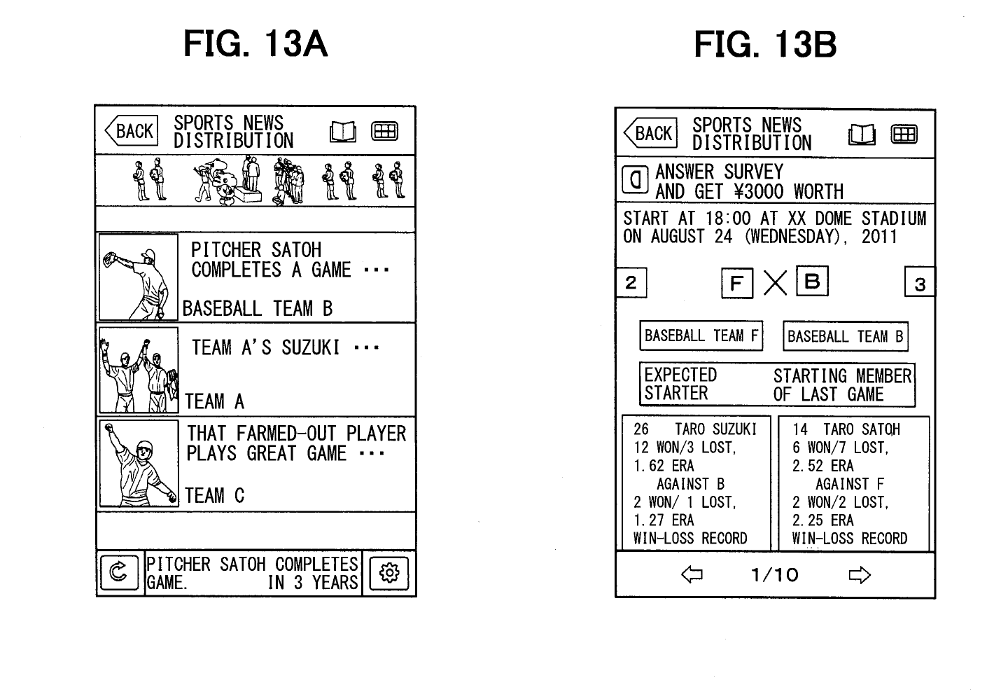

On the contrary, when the portable communication terminal 3 uses contents alone by comparison, the portable communication terminal 3 displays a list screen as shown in FIG. 13A. When any one item of news is selected by the user, the portable communication terminal 3 displays a detailed screen as shown in FIG. 13B. The detailed screen of FIG. 13B contains, for example, ten pages of screen and photo images are contained in latter pages. In other words, contents acquired from the content server 6 contain more detailed information, such as the outcome of a game and overall records, as well as photo images.

By limiting types of information to be displayed and setting a display region in advance and displaying the information using the region as an upper limit, the vehicle device 2 reduces an information amount to be displayed in comparison with a case where the portable communication terminal 3 uses the content alone.

It should be also noted that the vehicle device 2 can use other contents in addition to sports information. For example, assume that the user touches an icon I3 corresponding to a photo search service (a service to store photographs appended with location information in the content server 6 and provide the stored photographs, which is capable of setting a destination according to the location information of a photograph) on the home screen shown in FIG. 5. Then, the vehicle device 2 performs the processing to acquire contents as described above and subsequently outputs the contents (B6) in the information display processing depicted in FIG. 6.

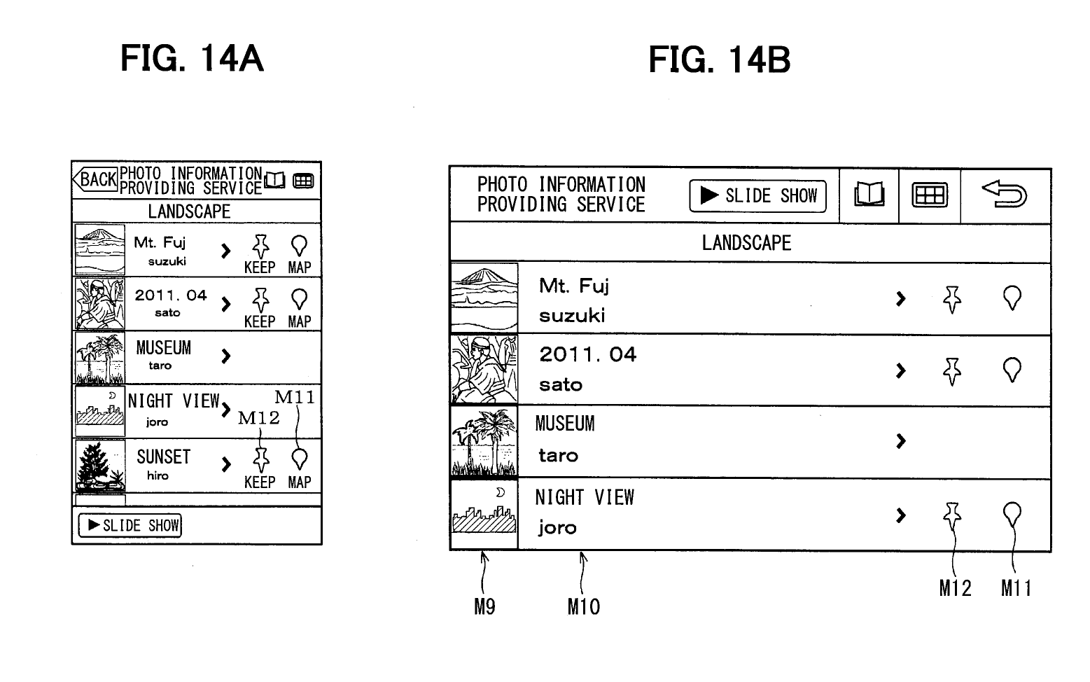

In this instance, the vehicle device 2 displays a screen as shown in FIG. 14B. By comparison, the portable communication terminal 3 displays thereon images as shown in FIG. 14A. Screens in FIG. 14A and FIG. 14B are provided with thumbnail display portions M9 for images (thumbnails) and user display portions M10 in which to display names of users who posted the images. When images are appended with location information, a destination button M11 and a spot keep button M12 are also displayed. The destination button M11 is a button used to input an operation to set a facility or a location specified by an image as a destination in the navigation function. The spot keep button M12 is a button used to input an operation to save a facility or a location specified by an image as favorite information (register in Spot Keep).

In the information display processing depicted in FIG. 6, when the content contains the location information (B7: YES), the vehicle device 2 determines whether the destination button M11 is operated (B8), whether the spot keep button M12 is operated (B11) and whether an update or end operation is performed (B13). When none of these operations is performed (B8: NO, B11: NO, and B13: OTHER), the vehicle device 2 stays on standby.

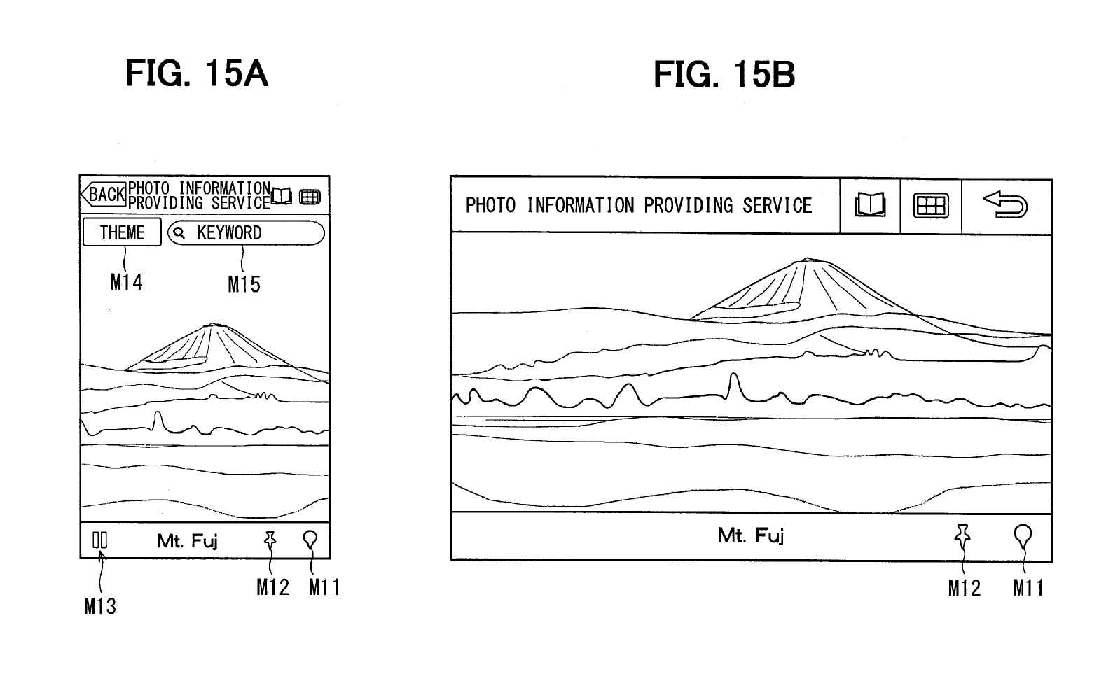

When any one of the images is selected in this instance, the vehicle device 2 displays detailed information shown in FIG. 15B. Herein, only the destination button M11 and the spot keep button M12 are displayed on the vehicle device 2 whereas, as is shown in FIG. 15A, a slide-show button M13, a theme button M14, and a keyword input button M15 are further displayed on the portable communication terminal 3. The slide-show button M13 is a button to play or stop a slide show to successively switch images. Hence, when the slide show is being played, a list of the acquired images is displayed on the portable communication terminal 3 while the images are successively switched.

On the contrary, the slide-show button M13 is not displayed on the vehicle device 2 and only one image is displayed. In short, the vehicle device 2 reduces an information amount by the method (c) above.

The theme button M14 and the keyword input button M15 provided on the side of the portable communication terminal 3 are buttons to set a refinement condition according to which images are filtered in the content server 6. By inputting a theme (pre-set keyword) or an arbitrary keyword, the user can filter a myriad of images stored in the content server 6 to those he wishes to view. The theme button M14 and the keyword button M15 are not shown in FIG. 15B on the vehicle device 2 running the common application because operations on these buttons are restricted by the traveling restriction processing. That is to say, the travelling restriction processing may restrict a display itself on the screen besides an input of an operation.

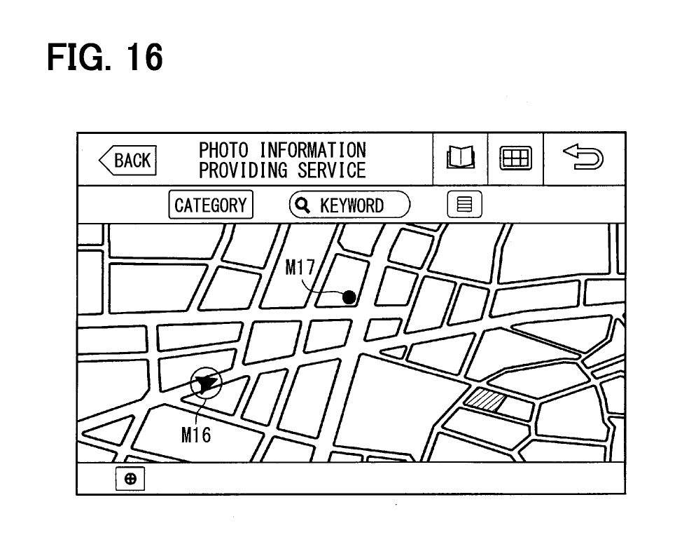

When the user operates the destination button M11 shown in FIG. 14B or FIG. 15B, because the destination button M11 is operated (B8: YES) in the information display processing depicted in FIG. 6, the vehicle device 2 sets a destination according to the location information of the content (B9) and displays a map screen as shown in FIG. 16 (B10). As is known, the map screen not only displays an own car mark M16 specifying a location of the vehicle and a destination mark M17, but also provides a guidance on a route to the destination. Also, when the spot keep button M12 is operated (B11: YES), the vehicle device 2 registers the image or a facility specified by the image into Spot Keep (B12).

In this manner, the vehicle device 2 uses various types of information provided by the information distribution service.

According to the embodiment described above, advantages as follows can be obtained.

The vehicle device 2 can operate in cooperation with the portable communication terminal 3 and also run an application that makes contents provided from the outside content server 6 available in a configuration common with the portable communication terminal 3. In this instance, the vehicle device 2 performs the content edit processing to reduce an information amount of detailed information contained in a content for which a selection operation was made by the user to be less than an information amount of the detailed information displayed on the portable communication terminal 3. The vehicle device 2 thus displays the content with an information amount reduced by the content edit processing. Accordingly, an information amount displayed on the screen is reduced and a screen easy to see for the user can be provided by the vehicle device 2, too. Hence, the convenience when the information distribution service is used in the vehicle can be enhanced.

By performing the content edit processing using the methods (a) through (d) above, the vehicle device 2 can reduce an information amount for various contents and depending on types of detailed information contained in the contents.

When the read more button M5 or the voice button M6 is operated by the user, the vehicle device 2 outputs the text data in the detailed information contained in the acquired content in a voice. Hence, the vehicle device 2 can prevent the convenience from being lowered more than necessary while providing a screen easy to see for the user.

The vehicle device 2 determines whether the vehicle is traveling or not on the basis of the vehicle information, and upon determining that the vehicle is traveling, performs the traveling restriction processing to restrict an operation on respective buttons or a display itself on the vehicle device 2. Owing to this configuration, a risk that the user fixes his eyes onto a screen can be lowered.

Also, an input of an operation to the portable communication terminal 3 is restricted while the portable communication terminal 3 is connected to the vehicle device 2. Hence, an operation on the portable communication terminal 3 while the vehicle is travelling can be prevented. Safety while the vehicle is traveling can be thus enhanced.

By running the information display program to perform the control as above on the vehicle device 2 and according to the vehicle system 1 using the vehicle device 2, safety when the information distribution service is used in the vehicle can be enhanced as has been described above.

### OTHER EMBODIMENTS

The embodiment above has described a case where the text data is read in a voice by an operation of the user. However, text data may be read in a voice automatically without an operation by the user. Also, it may be configured in such a manner that text data is read in a voice automatically while the vehicle is travelling.

The embodiment above has described a case where summaries written in the RSS fields M21(I) and M21(II) are extracted. However, the vehicle device 2 may acquire a body text of an article and create a summary.

The embodiment above has described that Bluetooth (registered trademark) is adopted as a communication system between the vehicle device 2 and the portable communication terminal 3. However, the communication system is not limited to Bluetooth (registered trademark). For example, other wireless communication systems, such as a wireless LAN so-called a Wifi and a wireless USB that is a wireless version of USB, may be adopted as well. Further, a cable communication system, such as USB, can be also adopted.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A device for a vehicle that utilizes a content provided from an outside server by functioning in cooperation with a portable communication terminal that solely executes an application for utilizing the content, the device comprising:
a communication device that communicates with the portable communication terminal;
a display device that displays a plurality of contents acquired by the communication device via the portable communication terminal;
an operation input device that inputs an operation for selecting one content from the plurality of contents displayed on the display device and for controlling the display device to display detailed information included in the one content; and
a control device that performs a content edit process for reducing an information amount of the detailed information included in the one content to be less than an information amount of detailed information displayed on the portable communication terminal when the display device displays the detailed information included in the one content, and controls the display device to display the one content with an information amount reduced by the content edit process,
wherein the control device reduces the information amount by preliminary setting a display region of the display device for each type of the detailed information, and setting an information capacity of each display region as an upper limit of a display configuration.

2. (canceled)

3. The device for the vehicle according to claim 1,
wherein the control device preliminary sets a size of a character to be displayed on the display device.

4. The device for the vehicle according to claim 1,
wherein the control device reduces the information amount by preliminary setting a type of the detailed information to be displayed as a display object in the detailed information, and extracting and displaying the detailed information having a preliminary set type.

5. The device for the vehicle according to claim 1,
wherein the control device reduces the information amount by displaying any one piece of the detailed information when the detailed information includes more than one piece of information having a same type.

6. The device for the vehicle according to claim 1,
wherein the control device reduces the information amount by extracting or creating a summary of information including a text data among the detailed information and by displaying the summary.

7. The device for the vehicle according to claim 1, further comprising:
a sound output device that outputs a sound,
wherein the control device outputs a text data, included in reduced information among the detailed information, with a sound from the sound device.

8. The device for the vehicle according to claim 1, further comprising:
a vehicle information acquisition device that acquires vehicle information for determining whether the vehicle is traveling,
wherein the control device determines based on the vehicle information whether the vehicle is traveling, and executes at least one of an operation to restrict an input operation to the operation input device and an operation to restrict a display on the display device as a traveling restriction process when the control device determines that the vehicle is travelling.

9. The device for the vehicle according to claim 1,
wherein the application for utilizing the content provided from the outside server is executed by the portable communication terminal,
wherein the display device displays an operation screen image of the application executed by the portable communication terminal,
wherein the operation input device inputs an operation performed by the portable communication terminal, and
wherein the control device utilizes the content in cooperation with the portable communication terminal by instructing the portable communication terminal to execute the application for utilizing the content according to an operation inputted into the operation input device.

10. The device for the vehicle according to claim 1,
wherein the portable communication terminal restricts an input operation to a terminal-side operation input device arranged in the portable communication terminal when the portable communication terminal is connected to the vehicle device.

11. A non-transitory tangible computer-readable medium comprising instructions being executed by a computer, the instructions including a computer-implemented method for executing an application to utilize a content provided from an outside server in a common configuration with a portable communication terminal by functioning in cooperation with the portable communication terminal, the instructions including:
communicating with the portable communication terminal;
displaying a plurality of contents acquired from the outside server via the portable communication terminal by communicating with the portable communication terminal;
receiving an operation to select one content from the plurality of contents displayed while displaying the plurality of contents, and to display detailed information included in the one content; and
performing a content edit process for reducing an information amount of the detailed information included in the one content to be less than an information amount of detailed information displayed on the portable communication terminal by preliminary setting a display region for each type of the detailed information, and setting an information capacity of each display region as an upper limit of a display configuration when the detailed information included in the one content is displayed, and displaying the one content with an information amount reduced by the content edit process.

12. A system for a vehicle comprising:
a portable communication terminal that executes an application for utilizing a content provided from an outside server; and
a device for a vehicle that utilizes the content by functioning in cooperation with the portable communication terminal,
wherein the portable communication terminal includes:
a terminal-side display device that displays a plurality of contents acquired from the outside server;
a terminal-side operation input device that inputs an operation to select one content from the plurality of contents displayed on the terminal-side display device and to display detailed information included in the one content on the terminal-side display device; and
a terminal-side control device that controls the terminal-side display device to display the detailed information acquired from the outside server without reducing an information amount when the detailed information of the one content is displayed on the terminal-side display device, and
wherein the vehicle device includes:
a vehicle-side display device that displays the one content acquired via the portable communication terminal; and
a vehicle-side control device that controls the vehicle-side display device to display only a part of the detailed information acquired from the portable communication terminal by preliminary setting a display region of the vehicle-side display device for each type of the detailed information, and setting an information capacity of each display region as an upper limit of a display configuration when the detailed information of the one content is displayed on the vehicle-side display device.
